(19) United States
(12) Patent Application Publication
(10) Pub. No.: US 2003/0112211 A1
(43) Pub. Date: Jun. 19, 2003

(54) Active matrix liquid crystal display devices

(75) Inventor: Jason R. Hector, Redhill (GB)

Correspondence Address: PHILIPS ELECTRONICS NORTH AMERICAN CORP, 580 WHITE PLAINS RD, TARRYTOWN, NY, 10591, US

(73) Assignee: KONINKLIJKE PHILIPS ELECTRONICS N. V.

(21) Appl. No.: 10/315,805

(22) Filed: Dec. 10, 2002

(30) Foreign Application Priority Data
Dec. 15, 2001 (GB) 0130017.7

(51) Int. Cl. G09G 3/36

(52) U.S. Cl. 345/87

(57) ABSTRACT

An active matrix liquid crystal display device, comprising an array of liquid crystal display elements (12) having associated switching devices (11) and driven via sets of selection and data address conductors (14,16) by a peripheral control and driving circuit (25), is arranged to undergo a power down procedure when being turned off, in which the control and driving circuit, in response to a power down induction signal (PD) being received thereby, drives the display element electrodes (17) to a predetermined, low, voltage level such that the voltage across the LC material is below the threshold level. Thereafter, electrical power to the control and driving circuit is terminated. In this way, undesirable residual images which can otherwise be produced when turning the display device off are avoided.

This invention relates to active matrix liquid crystal display devices comprising a row and column array of pixels for producing a display output, each pixel comprising a liquid crystal display element and an associated switching device, and a driving and control circuit for driving the array of pixels.

Active matrix liquid crystal display devices (AMLCDs) suitable for displaying datagraphic or video information are well known and widely used in products such as monitors, mobile computers, personal digital assistants, mobile telephones and the like. Typical examples of such display devices, and their general manner of operation, are described in U.S. Pat. No. 5,130,829. Conventionally, the pixels comprise pixel electrodes organised in rows and columns on a first substrate and connected to sets of row and column address lines via their respective switching devices also carried on the first substrate. A second substrate carrying one, or more, electrodes is arranged spaced from the first substrate and liquid crystal (LC) material provided between the substrates. Selection and data signals generated by a driver circuit are supplied respectively to the row and column address lines. The driver circuit is arranged to address each row of pixels individually in turn by applying a selection signal to its associated row address line in a respective row address period to turn on the switching devices, typically comprising TFTs (thin film transistors), of the pixels in the row and at the same time data signals to the column address lines so that a data signal is loaded into each pixel in the row via a respective column address line. A storage capacitor is commonly provided in each pixel to store the data signal and maintain a desired voltage on the pixel electrode in the period until the pixel is next addressed. The data signals determine the display outputs of the individual pixels by virtue of the display elements modulating light. Each row of pixels in the array is addressed in sequence in this manner in respective row address periods, so as to build up a display picture from the array over one frame period, corresponding approximately to the number of pixel rows multiplied by the row address period. The array is repeatedly addressed in similar fashion in subsequent frame periods.

The LC display elements have a threshold level and when the voltage across the elements, as determined by the applied data signal, exceeds this level are driven to a fully transmissive, non-transmissive or intermediate gradation state corresponding to the level of the data signal so as to modulate input light accordingly.

Such display devices may be operable either in a reflective mode, in which the pixel display elements serve to reflect ambient light, in a transmissive mode in which light, for example provided by a backlight, is directed onto one side of the device and the display elements modulate the light to produce a display output visible from the other side of the device, or as a combination of the two (transflective).

When the display device is turned off and power supply to the drive circuit being discontinued, a residual image, based on the final addressed image, can remain which decays gradually, typically over several seconds. Before the image completely disappears, however, it often degrades to become a corrupted or distorted version of the final image which is both highly noticeable and unattractive, and as such undesirable. This effect is especially noticeable in a reflective type display device.

It is an object of the present invention to provide an improved active matrix liquid crystal device.

It is another object of the present invention to provide an active matrix liquid crystal display device in which the possibility of undesirable, distorted or corrupted, residual images occurring when turning off the device is at least reduced.

According to a first aspect of the present invention, there is provided an active matrix liquid crystal display device comprising a row and column array of pixels, each pixel comprising a liquid crystal display element having first and second opposing electrodes with liquid crystal material disposed therebetween and a switching device connected to the first electrode, sets of selection and data address conductors connected to the pixels, and a control and driving circuit connected to the sets of address conductors for driving the pixels, wherein the control and driving circuit is operable in response the supply of a power down indicative signal to an input thereof to drive at least the first of the first and second electrodes of the display elements to a similar and predetermined low voltage level such that the voltage across the liquid crystal material at the display elements is below the threshold voltage level of the liquid crystal material.

According to another aspect of the present invention, there is provided a method of powering down an active matrix liquid crystal display device having an array of pixels comprising liquid crystal display elements and associated switching devices, each display element comprising first and second electrodes with liquid crystal display material therebetween, and a control and drive circuit for driving the display elements to produce a display output, wherein the method comprises driving at least the first electrodes of the display element first and second electrodes to a similar and predetermined low voltage level at which the voltage across the liquid crystal material at the display elements is below the threshold voltage level of the liquid crystal material prior to electrical power to the control and driving circuit being switched off.

The relatively simple power down procedure performed by the control and driving circuit, assists in avoiding the aforementioned kind of disturbing display output from the pixel array after the display device is actually turned off and while any voltages present in the pixel circuits are decaying to an equilibrium (off-state) level. It has been established that the kind of the undesirable display output observed are due to charges present in the pixel circuits at the time of the display device being turned off being redistributed and consequently affecting display outputs from individual display elements before they decay to a sufficiently low level. The procedure ensures that the voltages present in the pixels immediately prior to the display device being turned off, with the electrical power supply to the control and driving circuit being terminated, are such that, with the voltages across the LC material being below the threshold level of the material, the display elements are held in a particular state, for example, fully transmissive, and remain in that state regardless of any charge sharing which may occur due to the effects of, for example, capacitances in the pixel circuits.

An important benefit of the invention is that the avoidance of the undesirable display outputs can be accomplished simply and conveniently without the need to provide any special, additional, circuitry. Moreover, the required operation can be carried out very quickly, typically for example within a standard frame period or considerably less. Driving of the display element electrodes to the predetermined voltage level can be effected easily through the control and driving circuit. In the power down phase, the pixels of the array may be driven by the circuit so as to set the voltage on the first electrodes of the display elements in the same manner as that used to address the pixels in normal operation of the device, i.e. by addressing each row of pixels in sequence, or with simple modification to a part of the circuit, e.g. the row selection (scanning) circuitry, by addressing either all the pixel rows or groups of pixel rows at the same time. During this operation, the set of address conductors that carry the data signals to the pixels are simply all held by the control and drive circuit at the appropriate voltage level.

Preferably, the predetermined voltage level is around zero (ground) volts. In known drive schemes, the display element second electrodes, which conventionally are constituted by a common electrode extending over the array of first electrodes, are held at a known, relatively low, voltage level, possibly around ground, during normal operation of the display device and so no substantial modification may be needed to the second electrode voltage control part of the control and drive circuit. It is usual for the set of address conductors carrying row selection signals, i.e. gating pulse signals for operating TFT (Thin Film Transistor) switching devices of the pixels, to be held at a predetermined level, typically corresponding approximately to a mid-level of the column line voltage range, when not being used for addressing their associated row of pixels.

In a preferred embodiment, the control and driving circuit is arranged further to set the set of selection address conductors to a voltage level at least close to the level of the predetermined voltage before the display element electrodes are driven to the predetermined voltage level and to return the set of selection address conductors to a level around the predetermined voltage level following this driving of the display element electrodes. This assists in ensuring that voltages present in the pixel circuits, and particularly voltages across the LC material, at the end of the procedure are at around the predetermined level, e.g. ground or 0 volts, and is beneficial particularly where the pixels in a row each include a storage capacitor coupled between the first display element electrode and a selection address conductor adjacent (preceding or succeeding) the selection address conductor associated with the pixels concerned, and especially in the case where a so-called capacitively coupled type of drive scheme is employed. In this, the selection signal waveforms applied to the selection address conductors comprise, in addition to the usual voltage pulse signal effective to turn on the TFTs of the selected pixel row in a respective row address period, and a lower, hold, level effective to maintain the TFTs off during the non-selection periods, a further, intermediate, voltage level synchronised with the row address period of a pixel row associated with an adjacent selection address conductor which intermediate voltage level contributes to the display element voltages obtained in the row of pixel being addressed.

In an alternative known storage capacitor configuration, the storage capacitors of a row of pixels may be connected to a respective, dedicated, storage capacitor conductor line rather than a selection address conductor. In this case, the control and driving circuit in the power down procedure preferably is arranged to set the storage capacitor conductor lines to a voltage level at least close to the predetermined voltage level before the display element first electrodes are driven to the predetermined voltage level and to hold them at that level until the power is turned off.

Embodiments of the invention will now be described, by way of example, with reference to the accompanying drawings, in which:

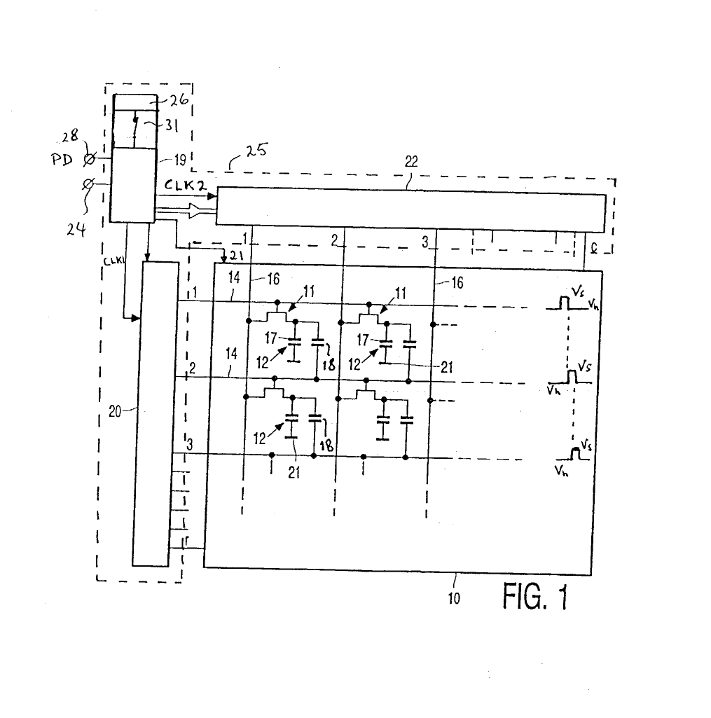

FIG. 1 is a simplified schematic block circuit diagram of an embodiment of AMLCD according to the present invention;

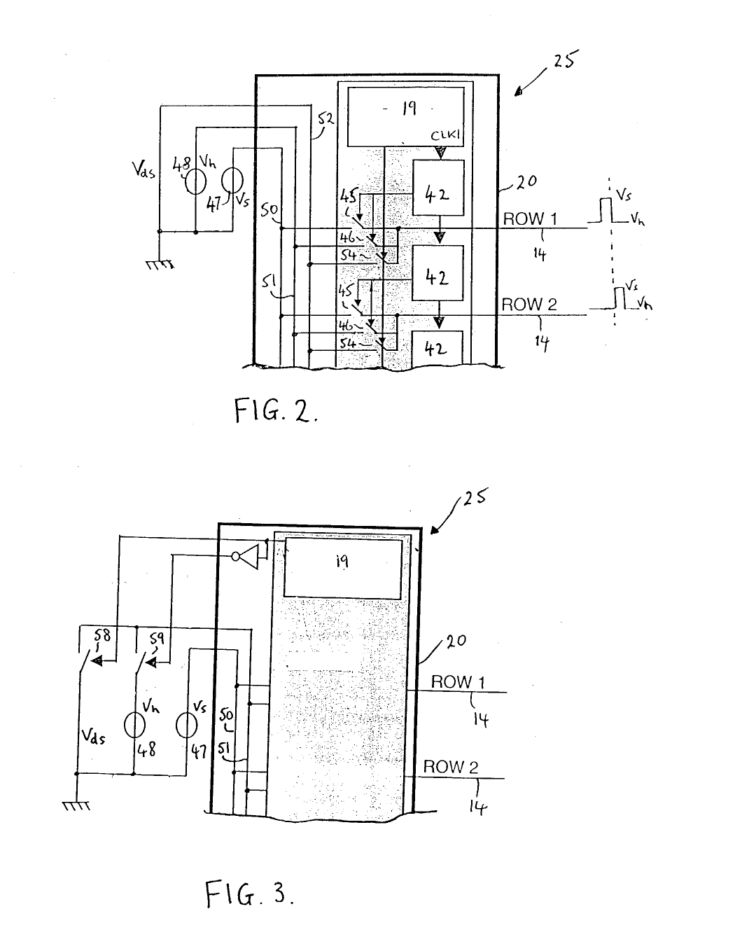

FIG. 2 shows schematically a part of the driver circuit of the display device of FIG. 1;

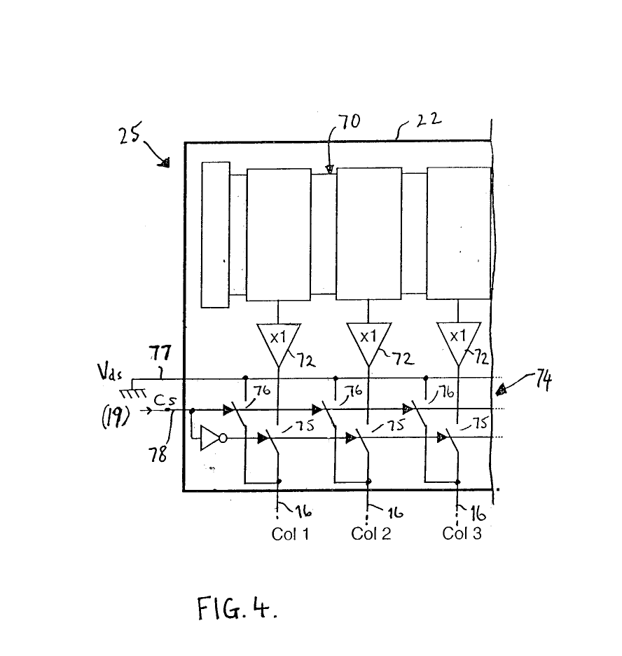

FIG. 3 shows schematically an alternative form of the part of the drive circuit of FIG. 2;

FIG. 4 shows schematically another part of the drive circuit of the device of FIG. 1.

It will be appreciate that the Figures are merely schematic. The same reference numerals are used throughout the Figures to denote the same or similar parts.

Referring to FIG. 1, the active matrix liquid crystal display device is in many respects of conventional form comprising a display panel 10 having a row and column array of pixels, each including a liquid crystal display element 12. Only a few are shown here for simplicity but in practice there can be several hundred rows and columns of pixels 12. The display elements each have an associated TFT (Thin Film Transistor) 11 acting as a switching device, and are addressed by row and column drive circuits 20 and 22 via sets of row, selection, and column, data, address conductors 14 and 16. The drain of a TFT 11 is connected to a respective display element first electrode 17 situated adjacent the intersection of respective row and column address conductors, while the gates of all the TFTs associated with a respective row of display elements 12 are connected to the same row address conductor 14 and the sources of all the TFTs associated with a respective column of display elements are connected to the same column address conductor 16. The sets of row and column address conductors 14, 16, the TFTs 11, and the picture element first electrodes 17 are all carried on the same insulating substrate, for example of glass, and fabricated using known thin film technology involving the deposition and photolithographic patterning of various conductive, insulating and semiconductive layers. A second glass substrate, (not shown) carrying a continuous transparent electrode 21 common to all display elements in the array and constituting display element second electrodes is arranged spaced from the substrate and the two substrates are sealed together around the periphery of the display element array and separated by spacers to define an enclosed space in which liquid crystal material is contained. Each display element electrode 17 together with an overlying portion of the common electrode 21 and the liquid crystal material therebetween defines a light-modulating display element. Both the general structure and operation of this device follow conventional practice, for example as described in U.S. Pat. No. 5,130,829 whose disclosure in these respects is incorporated herein as reference material.

The device of FIG. 1 is operable in reflection mode. The electrodes 17 are formed of light reflecting conductive material and light entering the front of the device through the second substrate is modulated by the LC material at each display element and, depending on their display state, reflected by the display element electrodes back through that substrate to generate a display image visible to a viewer. Alternatively, however, the device could be operable in transmissive mode with the electrodes 17 being formed of transparent conductive material and the individual display elements serving to modulate light directed onto one side of the device from a backlight according to their applied data signal voltages so that a display image can be viewed from the other side.

Each pixel further includes a storage capacitor 18 which is connected between the display element electrode 17 and a row conductor 14 adjacent that to which the TFT 11 associated with the display element is connected.

In operation, light is modulated according to the transmission characteristics of the individual display elements 12. The device is driven on a row at a time basis by scanning all the row conductors 14 sequentially with a selection pulse signal Vs in turn so as to build up over one frame a complete display image. Using one row at time addressing, all TFTs 11 of the addressed row are switched on for a period determined by the duration of the selection pulse signal, which corresponds to less than an applied video (image data) signal line period, during which display elements and their associated storage capacitors are charged according to the level of the data information signals, comprising analogue voltage signals, then present on the column conductors 16. Upon termination of the selection signal, the row conductors are returned to a relatively low voltage level, Vₕ, at which the TFTs 11 of the row are turned off, for the remainder of the frame time thereby isolating the display elements and storage capacitors 18 from the conductors 16 and ensuring the applied charge is stored on the storage capacitors and display elements until the next time they are addressed, usually in the next frame period. The voltage across the display element is selected to have a value in the range Vₜₕ (the threshold voltage level of the LC material) to Vₛₐₜ (the saturation level) to provide the desired gradation (grey-scale) between fully transmissive, white, and fully non-transmissive, black (or vice versa) according to the level of the data signal.

The row drive circuit 20 providing the selection signals is of generally conventional form consisting of one or more ICs and comprising a digital shift register circuit controlled by regular timing pulses, CLK1, from a timing and control circuit 19. For at least a major part of the intervals between selection signals, the row conductors 14 are supplied with the substantially constant reference voltage Vₕ. Data (video information) signals are supplied to the column conductors 16 by the column (source) drive circuit 22 which also is of generally conventional form, comprising one or more shift register/sample and hold circuits in the case of an analogue drive or digital to analogue converters and buffers in the case of a digital drive, and again provided in the form of one or more ICs. The circuit 22 is supplied with video information and timing pulses (CLK2) from the circuit 19 in synchronism with row scanning to provide serial to parallel conversion appropriate to the row at a time addressing of the panel 10. The image data and timing information is derived from a video signal applied to an input 24 of the circuit 19 and this circuit can include video signal processing functions. The timing and control circuit 19 and drive circuits 20 and 22 together constitute a control and driving circuit, as indicated in dashed outline at 25. Like the circuits 20 and 22 the circuit 19 is of a generally conventional kind as regards its generation and supply to the circuits 20 and 22 of timing and video information signals. A power supply circuit 26 is associated with the circuit 19 and provides the necessary power for energising and operating the circuit 19 and the various voltage levels required by the circuits 20 and 22 to perform their functions. The circuit 19 may in practice be combined with either the row or column drive circuit. The control and driving circuit 25, comprising the circuits 19, 20 and 22, and possibly also the power supply circuit 26, may be constituted by just one or a plurality of ICs. As examples of typical voltage levels employed in operation of the device, the selection signals Vₛ may be around 20V, the hold level Vₕ may be around 8V, the common electrode 21 may be at around 0V-2V, and the column, data, signal voltage range lines between the Vₛ and Vₕ levels.

As is customary in liquid crystal display devices, the polarity of the voltages supplied to the display elements is periodically inverted. This inversion occurs after every frame (so-called frame inversion). Row inversion, in which in a given frame the polarity of the voltages on two adjacent rows is inverted, may be used in addition.

In known display devices of a similar kind then upon the display device being turned off and electrical power to the control and driving circuit being terminated the display elements of the array retain the states into which they were last driven as their associated TFTs will be in their off state and the LC material has a relatively long time constant for decay. Moreover, the outputs of the ICs constituting the row and column driver circuits 20 and 22 connected to the address conductors 14 and 16 will then be free to drift. As these outputs, and hence the address conductors, gradually discharge the voltages of the address conductors approach ground potential. Because the row conductors 14 are all (apart perhaps from one) at a relatively low voltage, Vₜₕ, so as to hold their associated TFTs 11 in the off state, their discharge towards ground will couple charge through the storage capacitors 18 onto the display elements 12, thereby changing the voltage across the LC material. As a consequence, the transmission characteristics of individual display elements can change and as this is not a controlled process the changes in individual display elements can vary over the array, resulting in a corrupted and unattractive display image output. This effect, which may last for several seconds following turn-off, is especially noticeable in devices operating in reflective mode, using ambient light. With transmissive mode, back-lighted, devices, the back-light is normally extinguished when the device is turned off so the above desired effects are much less apparent.

To avoid these undesirable effects, the display device is arranged to undergo a power down procedure at the time the device is being turned off. The procedure is performed and controlled by the control and driving circuit 25 and initiated in response to a power down indicative signal PD being supplied to an input 28 thereof. This signal may, for example, be generated by as a result of the manual activation by a user of a main power on/off switch of the display device, such as the power button on a mobile phone, PDA or the like, or alternatively may be generated automatically by a system controller in the product incorporating the display device, as, for example, in the case of a display sleep mode operation in a laptop computer or PDA.

In this power down procedure, driving of the pixel array in accordance with supplied video information is discontinued and the control and driving circuit 25 operates in response to such a power down indicative signal received thereby to drive all the display element first electrodes 17 to a similar, predetermined, low voltage level. V_{ds}, preferably zero volts, and also the common electrode 21 if this is not already at around that level, so that the voltage across the LC material in the display elements is below the threshold level. This may be accomplished through driving the display elements in the normal fashion by the circuit 20 scanning each row of pixels in turn with a selection signal and by the circuit 22 applying the appropriate voltage level i.e. zero volts, to the column address conductors 16. Alternatively, the rows of pixels may instead all be selected simultaneously by applying a selection signal to all row address conductors 14 at the same time and applying zero volts to all the column address conductors 16 during the application of this selection signal. As a further alternative the rows of pixels may be selected in groups. At the same time as driving the display element first electrodes 17 in this manner, the common electrode 21 is also driven by the circuit 19 to substantially the same predetermined voltage, V_{ds}, i.e. zero volts, if it is not already set at this voltage in the immediately preceding normal display operation. The duration of the selection period of the pixel rows should be sufficient to charge, or discharge, the display elements to the predetermined voltage. For this purpose a selection period corresponding to a normal pixel row address period should be adequate.

At the termination of the selection signal applied to the row address conductors 14, either individually in turn or all together, the voltage on the row address conductors is set to the same predetermined voltage level V_{ds}, i.e. zero volts, rather than being returned to Vₕ.

Following this operation, the display element first electrodes, the sets of row and column address conductors, and the common electrode will all be at least substantially at the predetermined voltage level V_{ds}. This results in a plain field being displayed by the pixel array which, in the case of the display elements being configured so as to be normally “white”, i.e. fully transmissive at Vₜₕ or less, consists of a plain “white” image, (or conversely for normally “black” configured display elements, a “black image”) and with no, at least very little, DC voltage present on the display elements.

At this stage, electrical power supply to the control and driving circuit 25 is switched off through operation of a power supply switch in the circuit 19, as denoted at 31 in FIG. 1. Because the voltages present have been set as previously described, the risk of distortion or corruption in the displayed image is removed. Instead, the displayed plain image simply remains.

The display device may use a so-called capacitively and coupled drive scheme. In such a drive scheme, an example of which is described in WO99/52012, the waveforms applied to each row conductor 14 include, in addition to a selection pulse signal every field and a hold level for a major part of the remaining frame period, an intermediate voltage level whose timing coincides with the selection signal applied to an adjacent row conductor and which, by virtue of the storage capacitors of the pixels associated with that adjacent row conductor being connected to the row conductor concerned, contribute to the final voltage established on the display elements being addressed. When such a drive scheme is being used by the display device, it may be desirable in the power down procedure to set the row conductors to at least around the predetermined voltage level prior to the display elements being driven in the above-described manner so as to avoid unwanted voltages appearing across the LC material from subsequent transitions.

In summary, the power down procedure entails:

a) setting the set of column conductors 16 and the common electrode 21, and optionally the set of row conductors 14, to around the predetermined voltage level V_{ds}, e.g. 0 volts;

b) switching each row conductor 14 to the selection voltage level to select each row of pixels and returning each row conductor to around the predetermined voltage level after a period sufficient to charge or discharge to the display elements to around the predetermined voltage level, either one at a time in sequence, in groups, or all at the same time; and

c) thereafter turning off the supply of electrical power to the control and driving circuit 25.

The procedure, assuming the period for which a row of pixels needs to be selected to fully discharge the associated display elements corresponds approximately to a normal row address (line) period, can be accomplished within approximately one frame period or less. If the optional step of setting the row conductors 14 prior to selecting the rows of pixels is used then it is possible that the final display image may subsequently be distorted to a small extent. However provided the selection of the rows of pixels follows this step immediately, the time in which such distortion could occur is relatively brief, much less than one frame period, and so the effect will not be noticeable.

FIG. 2 shows schematically a part of one example of the control and driving circuit 25 adapted to perform the power-down procedure, and more particularly a section of the row drive circuit 20 driving two row conductors 14, row 1 and row 2. As in known row drive circuits, circuit 20 comprises shift register stages 42 operable in succession by clocking signals CLK1 from a timing control circuit in the circuit 19 to connect each row conductor 14 selectively via switches 45 and 46 in each stage to voltage supply lines 50 and 51 connected to voltage sources 47 and 48 in the circuit 19 and providing the selection signal voltage Vₛ, and hold voltage, Vₕ, levels respectively. In normal display operation, the stages 42 operate their associated switches 45 and 46 alternately so as to generate on the row conductors 14 the kind of waveforms depicted in FIG. 2, the waveform on each row conductor thus comprising a hold level Vₕ and a selection signal level Vₛ for selecting the row concerned, the selection signals for successive row conductors being temporarily separate. The default state of the switches 45 and 46 is open. The circuit illustrated is suitable for the case where only a two level row waveform drive scheme is employed. For a so-called capacitively coupled drive scheme, in which the row conductor waveforms include at least one other intermediate voltage level, a further switch and voltage source would be provided for this purpose.

The circuit further includes an additional voltage supply line 52 which is held at the predetermined voltage level, here shown as ground, and a further switch 54 in each stage that is operable directly by the control circuit 19. In response to a power-down initiation signal being received by the control and driving circuit 25, and with the switches 45 and 46 being in their default, open, state, the control circuit 19 operates to close the switch 54 in each stage so as to connect the row conductors 14 to the ground supply line 52, and therefore set the row conductors to the Vds level, when required.

FIG. 3 shows schematically an alternative form of part of the control and driving circuit 25 suitable for this purpose, the part again consisting of a section of the row drive circuit 20 associated with two row conductors 14. The row drive circuit 20 is generally similar to that of FIG. 2 except that it does not have the additional switch 54 and voltage supply line 52. Instead, the voltage supply line 51 is switchable between the predetermined level, ground, and the hold level Vₕ under the control of the control circuit 19. The circuit 19 operates the switches 58 and 59 alternately such that in normal display operation the voltage line 51 is connected to the Vₕ voltage source 48 via the switch 59 and such that during the power down procedure the line 51 is connected to ground via the switch 58, thereby ensuring that each row conductor 14 is held at ground except for the time it is selected in order to drive its associated display elements to the predetermined voltage level (ground).

FIG. 4 shows schematically a different part of the control and drive circuit 25, and more specifically a portion of the column drive circuit 22. The column drive circuit generates data signals for each of the column conductors 16 by means here of a DAC and buffer circuit arrangement of conventional form, denoted generally at 70, each data signal having a range of possible voltage values that determine the grey-scale output level from the display element being addressed. The data signals are supplied to the individual column conductors 16 via respective buffer amplifiers 72. Connected between the buffer amplifier outputs and the column conductors 16 is a switching arrangement 74 comprising a pair of switches 75, 76 corresponding to each column conductor which are operable so as to connect each column conductor 16 either with a respective buffer amplifier output or to a common voltage line 77 held at ground potential. In normal display operation the switches 75 connecting the column conductors to the outputs of their respective buffer amplifiers 72 are closed. Upon receipt by the control and timing circuit 25 of a signal indicative of power down, a switching signal Cs is applied to the switch control line 78 that is effective to open the switches 75 and close the other switches 76, thereby resulting in the column conductors 16 being set at ground (0 volts). When subsequently the pixels rows are selected during the power down procedure, the display elements are driven to this voltage.

A simple switching arrangement (not shown) similar to one section of the arrangement 74 is employed to switch the voltage applied to the common electrode between its normal drive level and ground level substantially simultaneously with the operation of the switching arrangement 74.

It will be appreciated that the above-described circuits are given by way of example and that alternative forms of circuits for achieving the required operation in the power-down procedure could be used.

In summary, therefore, an active matrix liquid crystal display device, comprising an array of liquid crystal display elements having associated switching devices and driven via sets of selection and data address conductors by a peripheral control and driving circuit, is arranged to undergo a power down procedure when being turned off, in which the control and driving circuit, in response to a power down initiation signal being received thereby, drives the display element electrodes to a predetermined, low, voltage level such that the voltage across the LC material is below the threshold level. Thereafter, electrical power to the control and driving circuit is terminated. In this way, undesirable residual images which can otherwise be produced when turning the display device off are avoided.

From reading the present disclosure, other modifications will be apparent to persons skilled in the art. Such modifications may involve other features which are already known in the field of active matrix liquid crystal display devices and component parts therefor and which may be used instead of or in addition to features already described herein.

1. An active matrix liquid crystal display device comprising a row and column array of pixels, each pixel comprising a liquid crystal display element having first and second opposing electrodes with liquid crystal material disposed therebetween and a switching device connected to the first electrode, sets of selection and data address conductors connected to the pixels, and a control and driving circuit connected to the sets of address conductors for driving the pixels, wherein the control and driving circuit is operable in response the supply of a power down indicative signal to an input thereof to drive at least the first of the first and second electrodes of the display elements to a similar and predetermined low voltage level such that the voltage across the liquid crystal material at the display elements is below the threshold voltage level of the liquid crystal material.

2. A display device according to claim 1, wherein the control and driving circuit is arranged to drive the first electrodes of the rows of display elements to the predetermined low voltage level one row at a time with a selection signal being applied to each selection address conductor in turn.

3. A display device according to claim 1, wherein the control and driving circuit is arranged to drive the first electrode of the rows of display elements to the predetermined low voltage level at the same time with a selection signal being applied to each of the selection address conductors in the set of selection address conductors in a common period.

4. A display device according to claim 2 or claim 3, wherein the control and driving circuit is further arranged to set each of the selection address conductors to a voltage level around the predetermined low voltage level immediately after the selection signal applied to the selection address conductor.

5. A display device according to claim 4, wherein the control and driving circuit is arranged also to set each of the selection address conductors to a voltage level at least close to the predetermined low voltage level immediately prior to the application thereto of the selection signal.

6. A display device according to any one of the preceding claims, wherein each pixel further includes a storage capacitor connected between its display element first electrode and a selection address conductor associated with an adjacent row of pixels.

7. A display device according to any one of claims 1 to 5, wherein each pixel includes a storage capacitor connected between its display element first electrode and a conductor line common to all pixels in the same row, and wherein the control and driving circuit is operable in response to the power down indicative signal to set the storage capacitor conductor lines to a voltage level at least close to the predetermined low voltage level immediately before the display element first electrodes are driven to the predetermined low voltage level.

8. A display device according to any one of the preceding claims, wherein the predetermined low voltage level is around zero volts.

9. A method of powering down an active matrix liquid crystal display device having an array of pixels comprising liquid crystal display elements and associated switching devices, each display element comprising first and second electrodes with liquid crystal display material therebetween, and a control and drive circuit for driving the display elements to produce a display output, wherein the method comprises driving at least the first electrodes of the display element first and second electrodes to a similar and predetermined low voltage level at which the voltage across the liquid crystal material at the display elements is below the threshold voltage level of the liquid crystal material prior to electrical power to the control and driving circuit being switched off.

10. A method according to claim 9, wherein selection address conductors connecting the pixels and the control and driving circuit and via which the pixels are selected by the control and driving circuit for driving the display elements are set to a voltage level at least close to the predetermined low voltage level after the first electrodes of the display elements are driven to the predetermined low voltage level and before electrical power to the control and driving circuit is switched off.

11. A method according to claim 10, wherein the pixels are arranged in rows and each row of pixels is selected to drive their display element first electrodes to the predetermined low voltage level in turn.

12. A method according to claim 10, wherein the pixels are arranged in rows and the display element first electrodes of all pixels are driven to the predetermined low voltage level at the same time.

13. A method according to any one of claims 9 to 12, wherein the predetermined low voltage level is around zero volts.
